(19) United States
(12) Patent Application Publication
(10) Pub. No.: US 2019/0270146 A1
(43) Pub. Date: Sep. 5, 2019

(54) FOLDING OUTFEED TABLES FOR TABLE SAWS

(71) Applicant: SawStop Holding LLC, Tualatin, OR (US)

(72) Inventors: Stephen F. Gass, West Linn, OR (US); Hollan A. Tsuda, Corvallis, OR (US)

(73) Assignee: SawStop Holding LLC, Tualatin, OR (US)

(21) Appl. No.: 16/288,939

(22) Filed: Feb. 28, 2019

Related U.S. Application Data
(60) Provisional application No. 62/638,449, filed on Mar. 5, 2018.

(51) Int. Cl. B23D 47/02; B23D 47/04; B23D 59/00

(52) U.S. Cl. CPC B23D 47/025; B23D 59/006; B23D 47/042

(57) ABSTRACT

Outfeed tables for table saws are disclosed. The outfeed tables may include adjustable clamps configured to adjust the height of the outfeed table relative to the table saw. Such outfeed tables may also include parts capable of being configured in multiple ways to accommodate various table saws.

### CROSS-REFERENCE TO RELATED APPLICATIONS

This application claims the benefit of and priority from U.S. Provisional Patent Application Ser. No. 62/638,449, filed Mar. 5, 2018, which is incorporated herein by reference.

### FIELD

The present disclosure relates to outfeed tables and particularly to folding outfeed tables for table saws.

### BACKGROUND

Power tools allow workers to produce goods with greater speed and less effort than is possible with manual tools. One type of power tool is a table saw, and it is one of the most basic and versatile machines used in woodworking. For example, table saws are used in making furniture and cabinetry, in the installation of hardwood flooring, in cutting plywood panels for roofing and walls, in cutting material for countertops, in making pallets and crates, and for many other projects and tasks. A table saw is a power tool used to cut a work piece, such as a piece of wood, to a desired size or shape. It includes a work surface or table and a circular blade extending up through the table. A person uses a table saw by placing a work piece on the table and feeding it into contact with the spinning blade to cut the work piece to a desired size.

It is sometimes necessary to cut large and/or long workpieces, but the weight of the workpiece as it extends beyond the rear edge of the blade can make such cuts difficult. Cabinet saws typically have between 6 and 12 inches of table space between the rear edge of the blade and the rear edge of the saw table. This distance makes it difficult to cut longer material because the material extending beyond the table is unsupported. To address this issue, different kinds of outfeed tables have been developed. An outfeed table is a structure with a generally flat, elongated top surface, which is placed behind a saw to provide support for long workpieces after they are cut. Prior outfeed tables, however, had the disadvantage of being difficult to adjust to accommodate different heights and widths of table saws, of being large and unwieldy to ship or move, and being difficult to store because of the space required by the outfeed table.

This specification describes an outfeed table designed to attach onto the rear portion of a power tool, such as a table saw. The outfeed table is configured so that it can be folded down and stored in a generally vertical orientation while still attached to the saw, which, for example, allows the saw to be more easily stored or moved. The outfeed table is also configured so that it can be shipped disassembled in a relatively small package, and can be assembled in multiple configurations using the same components in a variety of ways. The outfeed table can also include rollers disposed at the far edge of the outfeed table to prevent a workpiece from dragging along the rear edge of the table, and additional rollers can be disposed along the length of the outfeed table to minimize the drag of the workpiece.

### BRIEF DESCRIPTION OF THE FIGURES

FIG. 1 shows a table saw with a folding outfeed table.

FIG. 2 shows a table tube.

FIG. 3 shows a table support tube.

FIG. 4 shows a support leg.

FIG. 5 shows a roller attached to two table tubes.

FIG. 6 shows a roller and central plate attached to two table tubes.

FIG. 7 shows a top view of the arrangement of the table tubes of FIG. 1.

FIG. 8 shows a cross section of the connection between a table tube and a table support tube.

FIG. 9 shows an underside view of the outfeed table of FIG. 1.

FIG. 10. shows two table support tubes in a first alignment configuration.

FIG. 11 shows two table support tubes in a second alignment configuration

FIG. 12 shows an exploded view of a clamp assembly.

FIG. 13 shows the table saw and outfeed table of FIG. 1 with the outfeed table folded down.

FIG. 14 shows a side view of the table saw and outfeed table of FIG. 1 with the outfeed table shown partially folded in dashed lines and fully folded in solid lines.

FIG. 15 shows an alternate configuration of the table saw and outfeed table of FIG. 1.

FIG. 16 shows another alternate configuration of the outfeed table of FIG. 1 on an alternate saw.

### DETAILED DESCRIPTION

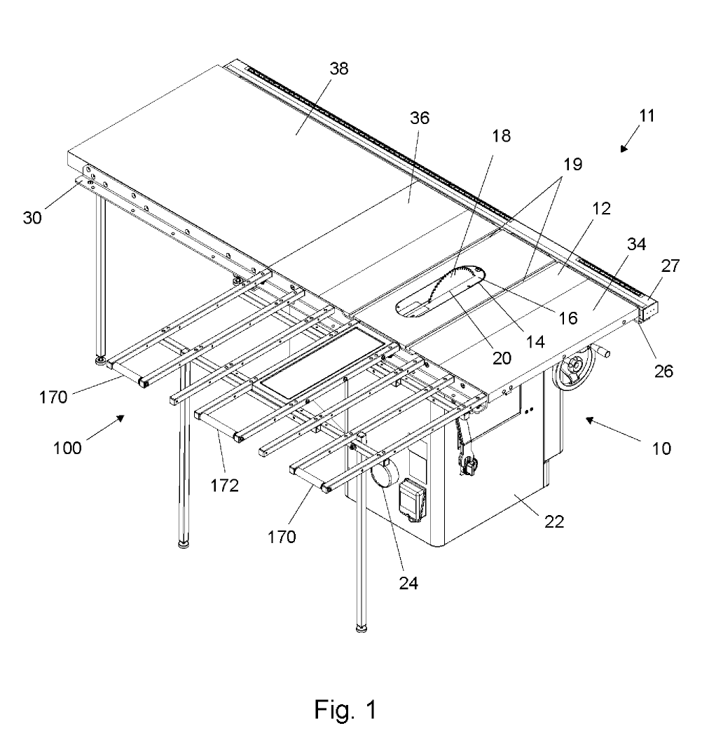

FIG. 1 shows a saw 10 having a table 12 and a circular blade 18 that extends up through a slot 20 in an insert 16, which sits in an opening 14 in the table. The top of the table can be described as a work surface. The table is supported by a support or housing 22. The saw also includes a motor to drive the blade. A piece of wood, or other material to be cut, is placed on the table and pushed into contact with the spinning blade to make a cut. The front of the saw is identified by number 11. The terms “vertical,” “horizontal,” “left,” “right,” “front,” and “rear” are used, and are intended to be interpreted from the perspective of a user standing at the front of the table saw facing the table saw. A dust port 24 is disposed on the rear side of housing 22, and a dust hose (not shown) can be attached between the dust port and a vacuum system to remove dust and particulates from the interior of the housing.

A front rail 26 and a front tube 27 are attached to the front edge of table 12, and a rear rail 30 is attached to the rear edge of the table. A fence, such as fence 32 shown in FIG. 16, can provide a face or surface to act as a guide against which a work piece can slide as a user moves the work piece into contact with the blade, and the fence can move left or right along the front and rear rails and the front tube to accommodate work pieces having different widths. A left extension wing 34 is attached to the left edge of table 12, and a right extension wing 36 is attached to the right edge of table 12, to accommodate work pieces of different sizes. An extension table 38 can be attached to the right edge of right extension wing 36, and the front and rear rails can extend along the extension table, as shown in FIG. 1. The end of extension table 38 which is farthest from the saw is supported by two extension legs 40, which are labeled in FIGS. 1, 14, and 15. Saw 10 can also be configured without left extension wing 34, as is shown in FIG. 16. Table 12 has two miter slots 19, which accommodate a miter gauge, as is known in the art.

FIG. 1 also shows an outfeed table 100 installed on table saw 10. Outfeed table 100 is attached to the rear of the saw. The outfeed table supports a work piece as the work piece moves off of the table past the rear edge of the table. The outfeed table is foldable so that it can pivot from an operating position as shown in FIG. 1 to a folded position where the outfeed table is generally vertically oriented against the rear of the housing for storage or to minimize the space occupied by the table saw, as discussed supra.

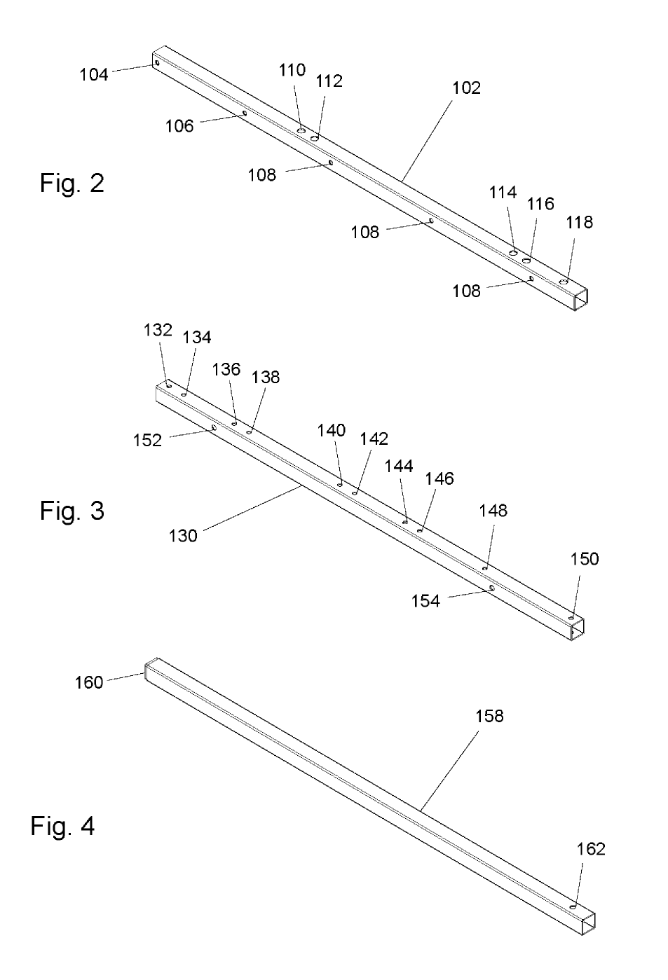

In the presently disclosed embodiment, three main components are used in the construction of the folding outfeed table: eight table tubes 102, four table support tubes 130, and two support legs 158. The three components are shown isolated in FIGS. 2, 3, and 4. The table tubes 102 are arranged to form a slatted table with a substantially planar top surface, the table support tubes 130 support the table tubes, and the support legs 158 maintain the position of the table when it is unfolded and installed on a saw, as is shown in at least FIG. 1. In the disclosed embodiment the tubes are made from 1″×1″ square, steel tubing, but it will be appreciated by one of ordinary skill in the art that other materials, shapes, and dimensions could be used to form the components of the outfeed table. Steel tubing is a common item and therefore easy and relatively inexpensive to source, which facilitates the manufacturing of the outfeed table. Additionally, designing the outfeed table from tubes means the components of the table can be easily packaged together without a large box which would be necessary for a unitary, single-piece table.

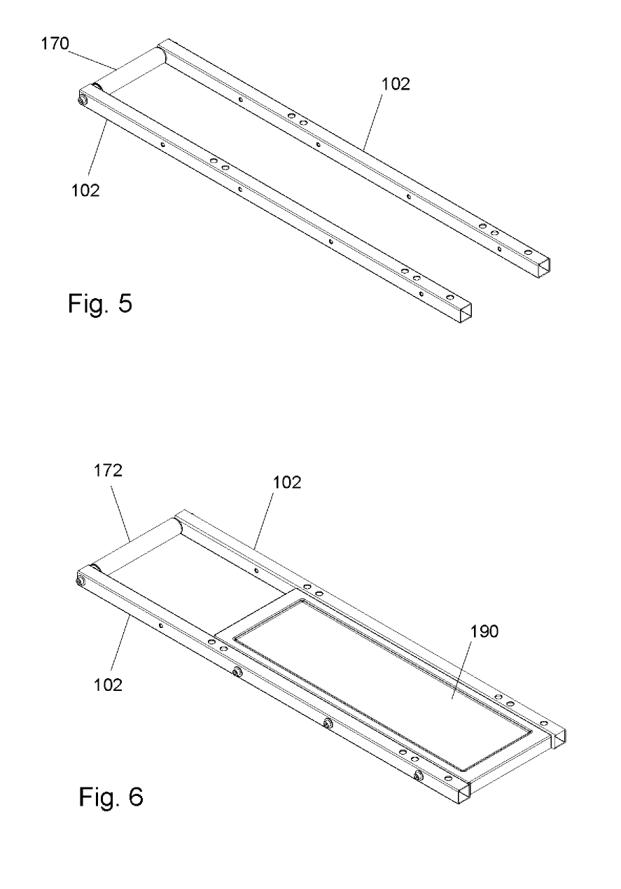

A table tube 102 is shown isolated in FIG. 2. The table tubes are designed to be identical, to simplify the manufacturing and assembly of the outfeed table and to facilitate various configurations thereof, as will be discussed. However, it will be appreciated that several kinds of table tubes could be used to form a single outfeed table. In the presently disclosed embodiment, the table tubes are all 31.85″ in length, but other lengths could be used. Each table tube 120 has five horizontal through-holes, shown at 104, 106, and 108, and five vertical through-holes shown at 110, 112, 114, 116, and 118 in FIG. 2. The range of holes allows the table tubes to be configured in a variety of ways while minimizing the number of different components required to assemble the outfeed table. The horizontal through-hole 104 can be used to install rollers at the rear end of the outfeed table to prevent workpieces from dragging on the table. FIGS. 5 and 6, respectively show rollers 170 and 172 attached to table tubes. Hole 106, which is slightly further in from hole 104, can be used to install additional rollers. The three holes 108 can be used to install a stabilizing central plate 190, as shown in at least FIGS. 1 and 6, or additional rollers, as can be seen in FIG. 16. The vertical through-holes 110 and 112 are paired near one another, as are vertical through-holes 114 and 116. Those holes can be used to mount the table tubes 102 to the table support tubes 130, as will be discussed. The solitary vertical through-hole 118 can be used to attach a clamp mounting bracket, as will be discussed later.

It can be advantageous to attach rollers between the table tubes to make it easier to pass a workpiece along the outfeed table, because the rollers decrease the friction on the workpiece as it travels away from the saw blade. It will be appreciated by one of ordinary skill in the art that the number and configuration of the rollers shown in the presently disclosed embodiment could be changed without departing from the scope of the invention.

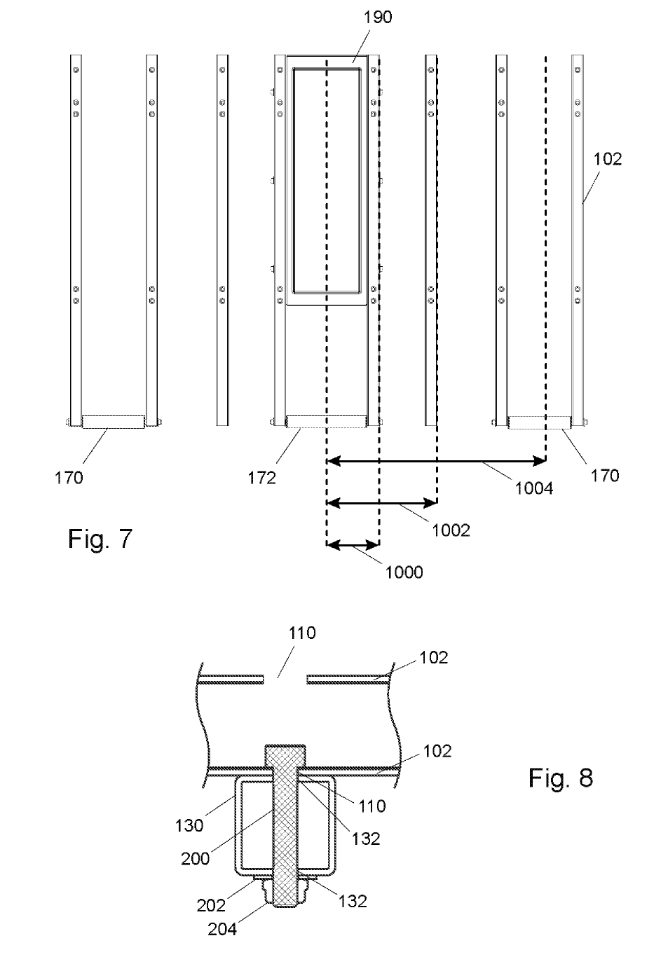

In the presently disclosed configuration, three rollers are mounted between the rear ends of six table tubes (relative to the front of saw 10) as shown in at least FIGS. 1 and 7. The middle roller 172 is longer than the other two rollers 170, as will be discussed. Each roller is mounted between two table tubes using rotatable bearings. In the presently disclosed embodiment, holes 104 in table tubes 102 are offset slightly toward the tops of the table tubes, so the rollers extend just beyond the top surfaces of the table tubes. This allows a workpiece to pass easily along the top of the outfeed table and onto the rollers. The holes 104 could be centered vertically on the table tubes if the diameter of the rollers was increased, but 1″ square tubing and 1″ diameter round tubing are both common parts, so it is simpler to manufacture the outfeed table if the hole 104 is simply offset toward the top of the tube. The tops of the rollers should be just above the tops of the table tubes, to minimize the drag of a workpiece as it gets further from the blade, as well as to minimize the angle of deflection between the end of the workpiece and the portion of the workpiece in contact with the blade.

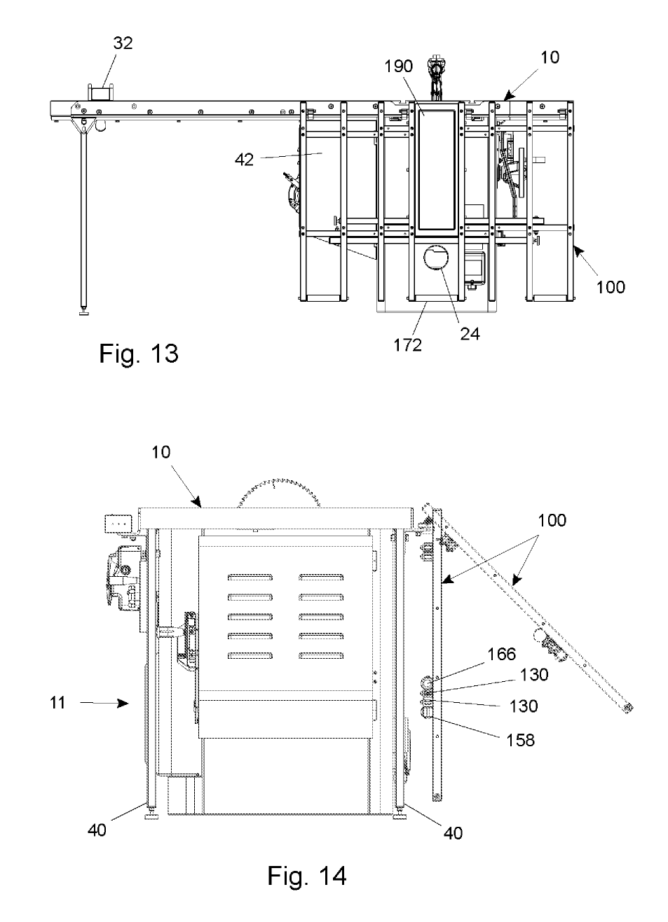

A bent metal central stabilizing plate 190 is mounted between the central two table tubes, as shown in at least FIGS. 1 and 6. The central plate 190 provides support for material near the plane of the blade as the material comes off the saw table and prevents the outfeed table from “racking” if lateral pressure is applied to the right or left edges of the table. The length of the central plate can be chosen to provide clearance for a dust port or other component installed on the rear side of the power tool when the outfeed table is in the folded (vertical) configuration. This can be seen in FIG. 13, which shows a dust port 24 on the rear of table saw 10 extending through the gap between the middle roller 172 and central plate 190. The sides of the central plate are folded down from the top surface to provide strength and to provide a way to bolt the central plate to two table tubes 102 through holes 108 in the table tubes. This design is advantageous because it allows the outfeed table to be fully disassembled and packaged very compactly, and the central plate keeps the outfeed table stable. Additionally, a user can replace the central plate with rollers, as will be discussed later. It will be appreciated that many methods could be used to attach the central plate to the table tubes, including welding or using more or fewer bolts.

A table support tube 130 is shown in FIG. 4. In the presently disclosed embodiment, each of the four table support tubes is 31.437″ in length, although other lengths could be used. Each table support tube has ten vertical through holes: 132, 134, 136, 138, 140, 142, 144, 146, 148, and 150, each of which is 0.252″ (6.4 mm) in diameter on both the top and bottom surfaces of the tube. Each table support tube also has two horizontal through holes, 152 and 154, each of which is 0.323″ in diameter. The ten vertical through holes can be used to attach the table tubes to the table support tubes, and the two horizontal through holes can be used to attach support legs to the table support tubes. Either two or four table support tubes are used to assemble folding outfeed table 100, and, as with the table tubes 102, only certain holes are used in each configuration, as will be discussed.

As stated, a person uses saw 10 by placing wood, or other material to be cut, on table 12 and pushing it into contact with the spinning blade 18. The part of the workpiece which has been cut is often referred to as the cutoff. A user often pushes a workpiece beyond the rear edge of the blade or table to minimize the chance of kickback or accidental contact with the blade. Additionally, the cutoff portion of longer workpieces often extends to, or beyond, the rear of the saw table 12 while the cut is being made. In either case, the cutoff portion of the workpiece is supported by the outfeed table. However, since the outfeed table is comprised of tubes with gaps between them, instead of a single, continuous component, there could be a risk of a workpiece “tipping” between the table tubes 102 and either becoming caught or falling between the tubes. This problem can be addressed by careful spacing of the table tubes, so that no more than half of the width of a cutoff piece is ever unsupported.

It will be appreciated that changing the width of the central plate would change the necessary minimum spacing between the table tubes. A general guideline for the spacing is that each tube can be 2*y*n from the beginning of the supported area directly behind the blade, where y is the width of the cutoff which is supported in the area directly behind the blade (i.e, 4.5″), and n is the sequential number of the table tube, counting away from the supported area. So, the first table tube on either side of the supported area directly behind the blade in the present embodiment must be less than (2)*(4.5″)*(1)=9″ from the beginning of the supported area.

In the presently disclosed embodiment, central plate 190 is behind blade 18, so the cutoff up to about 4.5″ on each side of the blade is continuously supported behind the blade, since the central plate 190 is 7″ wide, and has a 1″ wide table tube on each side. This area is indicated by a reference number 1000 in FIG. 7. So, a cutoff piece on one side of the blade could be twice the supported width (4.5″) without tending to tip and fall between the table tubes. The closest horizontal edge of the next table tube could thus be 9″ from the center of central plate 190, since a cutoff piece wider than 9″ would start to tip, since more than half the width would be unsupported. However, it can be advantageous to move the tube closer by 0.25-1″ in order to account for manufacturing tolerances or other circumstances. In the presently disclosed embodiment, the closest edge of the next table tube is 8.4″ from the center of central plate 190, which is just under double the width that is supported by the central plate 190 and the table tubes attached thereto. Since the tube is 1″ wide, the supported area extends 1″ beyond that edge, giving a total supported width of 9.4″ on either side of the plane of the blade. This area is indicated by reference number 1002 in FIG. 7.

Continuing the above-described pattern, since 9.4″ of cutoff would be supported between the center of central plate 190 and the far edge of the table tube, the next table tube could begin 18.8″ from the center of the central plate, giving a supported area shown by reference number 1002 in FIG. 7. However, it can be seen in at least FIGS. 1 and 7 that the depicted outfeed table 100 is not constructed in this manner. There are several design and use constraints accounting for this. First, the overall width of table 100 was chosen to be less than or equal to the width of saw table 12 and extension wings 34 and 36. Thus, the outermost tube on each side in the presently disclosed embodiment can be about 21″ from the center of central plate 190. However, in order to have two rollers at the rear corners of the outfeed table, another table tube 102 must be interposed within the 21″ of open space on each side. Since the outer three table tubes on each side are thus all within such a large margin of safety, the exact spacing therebetween can thus be chosen to be aesthetically pleasing. In this case, the spacings between the tubes were chosen to be about 4″, 5″, and 5.5″, with the space increasing for the tubes further from central plate 190. Additionally, if central plate 190 is not perfectly centered behind blade 18, the area 1000 supported directly behind the blade will be different for each side. This means that the spacing between the table tubes could be a ratio that would result in a cutoff piece tipping between the tubes. Thus, it is advantageous to include a factor of safety in the table tube spacing.

Table tubes 102 can be attached to table support tubes 130 in a variety of ways, including bolts, welding, or other methods. However, it is advantageous to use a removable method of attachment, so the outfeed table can be disassembled and/or reconfigured easily. In the presently disclosed embodiment, bolts are used to connect the table tubes and table support tubes. However, in order for a workpiece to slide smoothly across the top surface of the outfeed table, the screws must not project above the top surface of the table tubes. In the presently disclosed embodiment, the holes 110, 112, 114, 116, and 118 in table tubes 102 have a diameter of 0.43″ (11 mm) on the top side of the tube, but a diameter of only 0.25″ (6.4 mm) on the bottom side of the tubes. This allows insertion of bolts 200 to secure the table tubes to the support tubes, because the head of a bolts fits completely through larger side of the hole and then rests on the inside bottom surface of the tube, thus recessing the head of the bolt out of the way. The end of the bolt can then go through one of the vertical through-holes in a table support tube 130, and then a washer 202 and nut 204 can be placed on the bolt. This is shown in FIG. 8, which shows a straight-on view of the connection between a table tube 102 and a table support tube 130. In an alternate exemplary embodiment, conical depressions could be stamped into the tops of the table tubes to allow flat-head screws to be used, since the conical heads of the screws would fit into the conical depressions, thus maintaining the planar, top surface of the outfeed table.

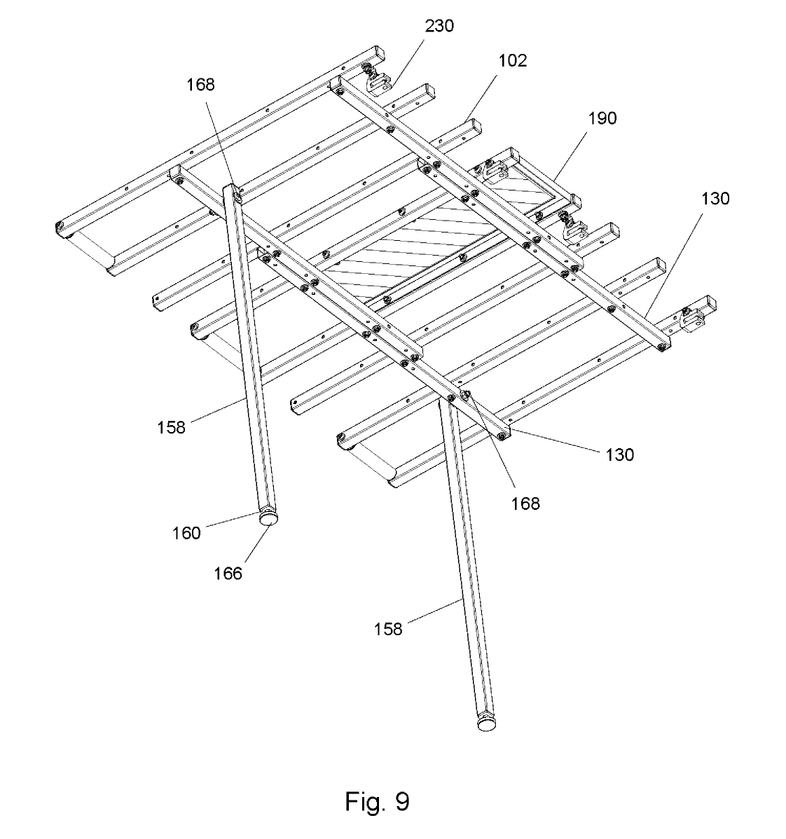

FIG. 4 shows a support leg 158. In the presently disclosed embodiment, both support legs are 32.677″ in height, although other heights could be used. A leveling foot 166 is threaded into a welded plate 160 in the base of each support leg (as can be seen in FIG. 9), and can be threaded in or out relative to the plate in order to adjust the overall length of the support leg structure. It will be appreciated by one of ordinary skill in the art that other methods of attaching leveling feet or changing the length of the support legs could be used within the scope of the present invention. Each support leg has a horizontal through hole 162 near the top of the leg. The holes are used to attach the support legs to table support tubes using bolts 168, as shown in FIG. 9. Each support leg is pivotally attached to a table support tube, so the legs can pivot around bolts 168 and fold up until they are parallel with the table support tubes, against the underside of the table tubes, as can be seen in at least FIG. 13. This allows the outfeed table to be easily and conveniently folded and stored out of the way, or the process can be reversed to unfold the table for use. The support legs are maintained in the folded or unfolded positions due to the friction created by the compression from bolts 168. In an alternate exemplary embodiment, a catch or lock could be used to secure the support legs in the folded and/or unfolded position.

Outfeed table 100 can be assembled in a wide configuration using four table support tubes, a middle configuration also using three or four table support tubes, or a narrow configuration using two table support tubes. When the folding outfeed table is installed on saw 10, it must not interfere with miter slots 19 in table 12, so central plate 190 and the two table tubes 102 attached thereto must be between miter slots 19. However, it is also advantageous if the outfeed table does not extend beyond the left edge of the saw table 12 (or left extension wing 34, if installed). Thus, the wide, middle, and narrow configurations of outfeed table 100 are designed to accommodate various saw dimensions and setups. These configurations are shown in at least FIGS. 1, 15, and 16, and will be discussed later in greater detail.

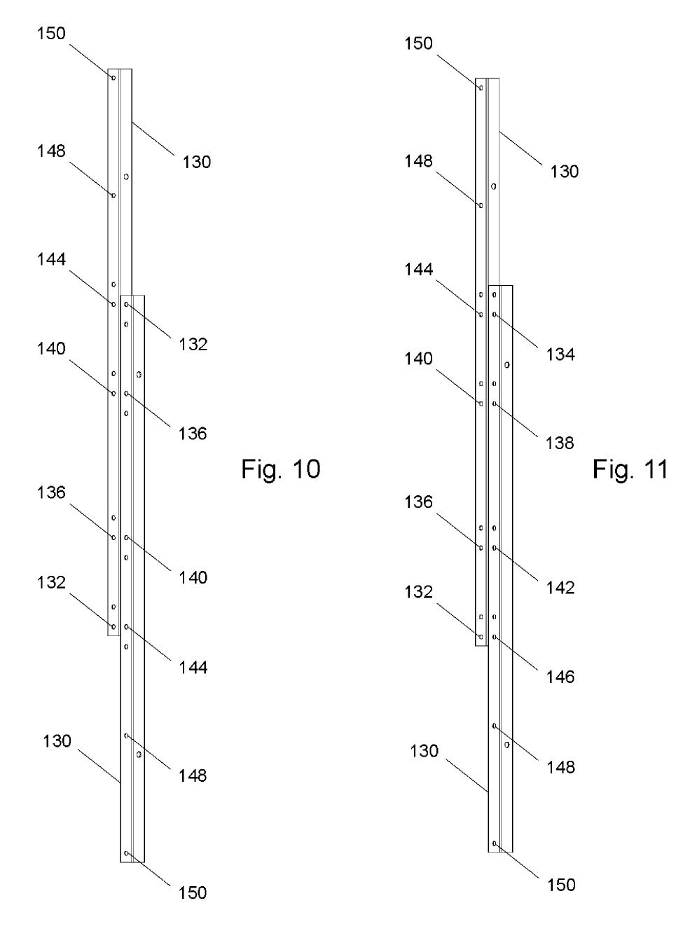

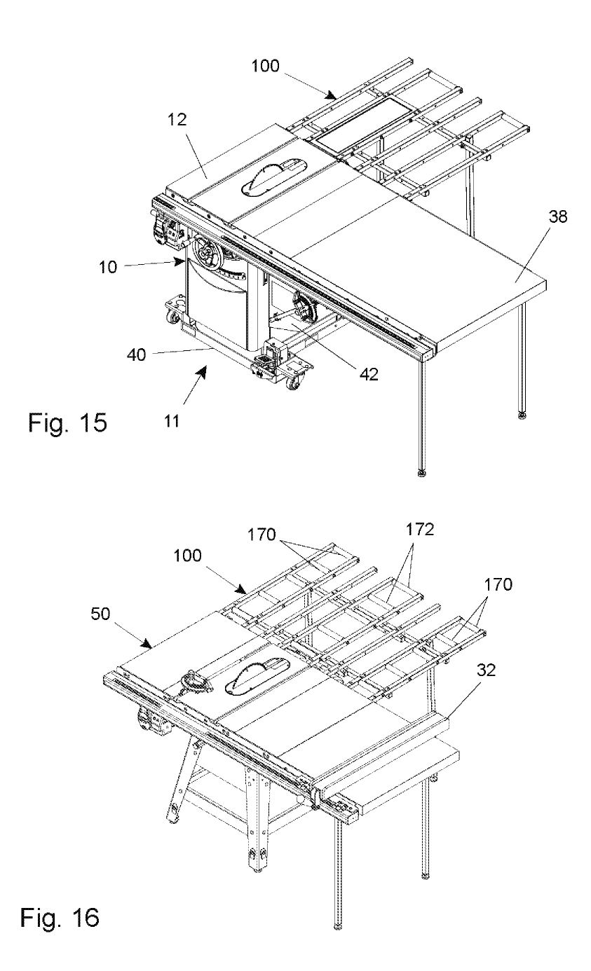

As stated previously, each table support tube 130 has ten holes. The table support tubes can be shifted laterally relative to one another so different holes line up between the table support tubes. This allows the table tubes 102 to be attached to the table support tubes 130 in several configurations to change the width of the outfeed table assembly, while maintaining the desired spacing between the table tubes 102 as discussed earlier. In the wide outfeed table configuration, table tubes 102 are attached to holes 148 and 150, and between the holes 144, 140, 136, and 132 which align with holes 132, 136, 140, and 144 in the other table support tube 130, as shown in FIG. 10. In both FIGS. 10 and 11, only the holes used in assembling the outfeed table are labeled with reference numbers. In the middle configuration, table tubes 102 are attached to holes 148 and 150, and between the holes 144, 140, 136, and 132, which align with holes 134, 138, 142, and 146 in the other table support tube 130. FIG. 15 shows the narrow configuration of outfeed table 100, which only uses two table support tubes instead of four. In this configuration, holes 132, 136, 140, 144, 148, and 150 in table support tubes 130 are used to attach table tubes 102. This configuration allows left wing 34 of saw 10 to be removed, so the edge of outfeed table 100 lines up with the left edge of table 12 and central plate 190 fits between miter slots 19 in table 12.

It will be appreciated that a long, single component could replace each pair of table tubes shown in FIGS. 10 and 11. However, such a design would be more difficult to package, and would require a unique set of components for each of the wide, middle, and narrow configurations, which would increase the manufacturing and distribution costs of the outfeed table. Additionally, it would prevent a user from being able to reconfigure the table as needed for different saw configurations.

The folding outfeed table is secured to the rear rail 30 of table saw 10 using clamps, as shown in at least FIGS. 1 and 13. It will be appreciated by one of ordinary skill in the art that many clamps could be used, but the adjustable clamps of the present embodiment are advantageous because they allow a user to configure the folding outfeed table to fit a variety of table saws, since the height and thickness of the rear rails on tables saws can vary significantly. The clamp assemblies are comprised of two main pieces: a clamp mounting bracket 250 attached to the underside of a table tube 102 and a clamp 232 attached to both the clamp mounting bracket and to the rear rail.

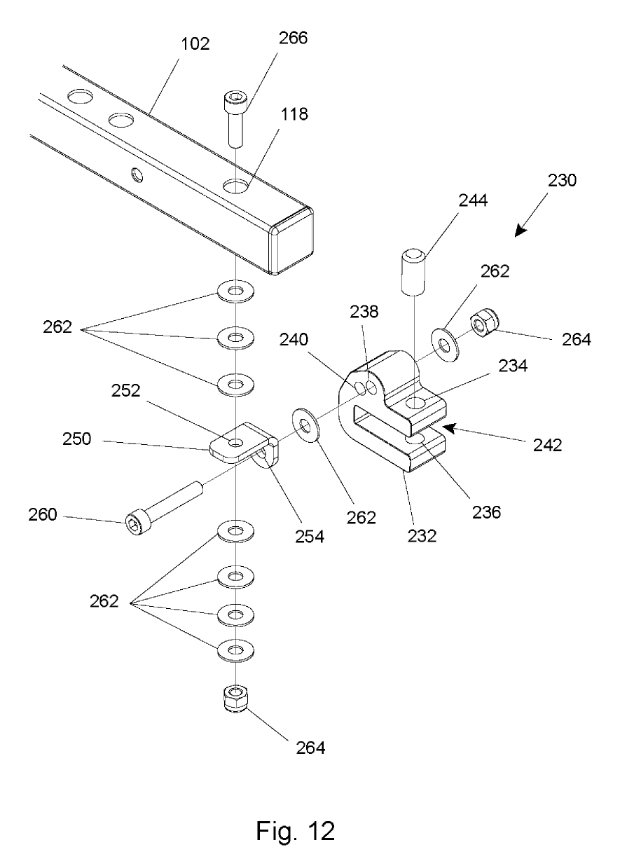

FIG. 12 shows an exploded view of a clamp assembly 230 and how a table tube 102 is connected thereto. Clamps 232 are shaped generally like C-clamps, although each one has two threaded clamping holes 234 and 236, as well as two non-threaded mounting holes 238 and 240. The clamps 232 can be made from extruded or cast metal, powdered metallurgy, or another material or method as is known in the art. The clamp mounting brackets 250 are made from bent sheet metal, with a hole 252 in the longer end and a hole 254 in the shorter end.

Each clamp mounting bracket 250 is attached to a table tube 102, and the clamps 232 are attached to the clamp mounting brackets. It will be appreciated by one of ordinary skill in the art that many methods of attaching clamp mounting brackets 250 to table tubes 102 could be used. For example, the clamp mounting brackets could be welded to the table tubes or connected thereto using more than one screw per bracket. Both options, however, prevent the clamp mounting bracket from moving or rotating relative to the table tube. Unless table tubes 102 were perfectly aligned with clamps 232, the clamp mounting brackets could interfere with the clamps as the outfeed table was folded and unfolded. The presently disclosed embodiment is advantageous because the outfeed table can self-align relative to the clamps as it is folded and unfolded, so the clamp mounting brackets are less likely to interfere with the clamps or bend due to the torques involved in folding and unfolding the outfeed table. It also allows for more significant variation and adjustment in the assembly of the folding outfeed table, since the locations and orientations of the clamps can be switched to accommodate various rail widths and features.

As shown in FIG. 12, clamp mounting bracket 250 is attached to clamp 232 through a screw 260, two washers 262, and a lock nut 264. The clamp mounting bracket is attached to table tube 102 by a bolt 266, which passes through hole 118 in the table tube, then through several washers 262, hole 252 in the long edge of the clamp mounting bracket, several more washers 262, and a lock nut 264.

The plurality of washers 262 allows the height of the table tubes relative to the saw table 12 to be adjusted. It is important that the top plane of the unfolded outfeed table not be higher than the saw table, or a workpiece could catch on the edge between the saw table and outfeed table. The top plane of the unfolded outfeed table should also not be significantly below the top of the saw table, or the workpiece could shift unexpectedly as it passed beyond the rear edge of the saw table. A user can adjust the height of the outfeed table relative to the saw table by changing the number of washers 262 between each table tube 102 and clamp mounting bracket 250. Increasing the number of washers used (i.e. using 15 washers instead of 7), but making them thinner, would increase the accuracy to which the height of the outfeed table could be adjusted, but would be more expensive to manufacture and it could be more difficult to set the clamps all at the same height.

The height of the outfeed table relative to the saw table can also be adjusted by switching the hole in the clamp 232 used to attach the clamp mounting bracket 250 to the clamp. Two horizontal holes, 238 and 240, pass through clamp 232, and can be offset in height by any desired increment (in this example 0.15″ (3.82 mm)). The two horizontal holes in each clamp 232 allow a user to easily switch the outfeed table between two different height configurations without having to adjust the number of washers between the table tubes and clamp mounting brackets.

A set screw 244 is threaded through either the top or bottom vertical threaded hole, 234 or 236 respectively, in each clamp 232 to secure the clamps to the rear rail. This allows for additional adjustment in the height the outfeed table relative to the saw table. It also allows the set screw to be moved out of the way if it would cause interference with components of the saw if it extended either up beyond the top of or down below the bottom of a clamp. For example, the motor housing covers on some saws do not have significant vertical clearance between the top of the motor housing cover and the rear rail, so a set screw extending underneath a clamp on the rear rail could scratch the motor housing cover. In that case, the set screw 216 could be threaded into the top hole 234, instead of the bottom hole 236. The motor housing cover in the exemplary saw 10 is indicated by reference number 42 in FIGS. 13 and 15.

Since the positions of the washers, horizontal holes in the clamps, and vertical holes in the clamps can all be used to adjust the height of the outfeed table, each of the clamp assemblies can be set up differently, depending on the space constraints of each location along rear rail 30 of saw 10. In the presently disclosed embodiment, the seven 1 mm thick washers 262 provide a total of 7 mm of vertical adjustment, the height offset between the two horizontal holes 238 and 240 provides 3.82 mm of vertical adjustment, and the difference in height between the upper and lower vertical, threaded holes 234 and 236 (the space indicated by reference arrow 242) provides 9.75 mm of vertical adjustment, minus the thickness of the rail being clamped. So, for a 5 mm thick rail, the presently disclosed clamp assembly has a total vertical adjustability of 15.57 mm.

Four clamp assemblies 230 are used in the wide and middle configurations, but only three are used in the narrow configuration. Also, the clamp assemblies can be assembled to extend to either the right or left of the table tube to which they are attached, which allows a user to make sure the set screws do not interfere with existing features on the rails such as holes or cutouts.

FIG. 1 shows the wide configuration of outfeed table 100, attached to table saw 10, in its unfolded, horizontal position. In this position, the upper plane of the table is substantially flush or slightly below the plane of table 12, and can be used as a support surface for cutoff material.

FIGS. 13 and 14 show outfeed table 100 folded down against the back of saw 10. When folded, the outfeed table can be thought of as being in a generally vertical position, where it is conveniently stored adjacent the saw, while remaining attached to the saw. In the folded position, the tops of the table tubes and table support tubes are generally vertical and are generally perpendicular to the ground. In order for the saw to remain usable, the ends of the table tubes must not extend above the top of table 12 when the outfeed table is folded. If end caps are installed in the ends of the table tubes (as can be seen in FIGS. 9 and 12), they also must not extend above the top of table 12.

FIG. 14 shows a side view of outfeed table 100 attached to saw 10, with the outfeed table shown partially folded in dashed lines and fully folded in solid lines. The outfeed table remains attached to the saw when it is folded down. It can be seen that the outfeed table does not extend substantially beyond the rear of saw 10 when the outfeed table is folded down. This minimizes the space necessary to store the saw 10 and outfeed table 100 when they are not in use. Outfeed table 100 can be easily folded and unfolded by a single user, since, as shown in FIG. 14, it pivots about a single axis, defined by bolts 260 in clamp assemblies 230. To fold the outfeed table, a user would simply grasp any part (i.e. a table support tube 102) to temporarily support the weight, fold support legs 158 up as described earlier, and lower the end of the table down, as shown by the dashed and solid lines in FIG. 14. The opposite process would be used to unfold the outfeed table.

FIG. 15 shows the narrow configuration of outfeed table 100 installed on saw 10, along with a mobile base 40, as is known in the art. When the outfeed table is folded down, saw 10 can still be moved easily on mobile base 40, since the table tubes 102 do not drag on the ground. So, the outfeed table can be compactly folded down out of the way, while maintaining the usability and mobility of the saw. It can also be seen in FIG. 15 that only one roller 170 and one roller 172 are used in the narrow configuration of the outfeed table, since only six table tubes 102 are used, not eight.

FIG. 16 shows the middle configuration of outfeed table 100 installed on an alternate saw 50. The outfeed table is shown with rollers mounted between all the horizontal through holes in six of the eight table tubes 102. The alternate saw 50 is narrower than saw 10, so the table support tubes are arranged in the manner shown in FIG. 11.

It is a feature of the presently disclosed invention that outfeed table 100 can be assembled in multiple configurations, which vary in width and height to accommodate a variety of table saws, using a minimum number of parts in numerous ways, which decreases manufacturing costs and increases the versatility of the outfeed table. It is also an advantage of the presently disclosed embodiment that it can be packaged in a small cardboard box, since the table tubes, table support tubes, and support legs are all 1″ square tubing and are similar enough in length to be stacked together. Since the outfeed table can be manufactured and shipped completely disassembled, it is cheaper to ship and can be set up by the user in a variety of configurations depending on the user's needs.

1. A table saw comprising:
a main table having a work surface and a rear edge,
a circular blade supported under the work surface and configured to extend at least partially above the work surface,
a housing supporting the main table, where the housing has a rear, and
an outfeed table adjacent the rear edge of the main table, where the outfeed table can pivot between an operating position where at least a portion of the outfeed table is configured to support a work piece as the work piece moves past the rear edge of the main table, and a folded position where the outfeed table is in a generally vertically oriented near the rear of the housing.

2. The table saw of claim 1, further comprising a clamp supporting the outfeed table adjacent the rear edge of the main table, where the outfeed table can pivot around an axis passing through a portion of the clamp.

3. The table saw of claim 1, further comprising a clamp supporting the outfeed table adjacent the rear edge of the main table, where the clamp includes a mechanism to adjust the height of the outfeed table in the operating position.

4. The table saw of claim 1, where the outfeed table includes a slatted table and at least one leg, where the slatted table has an underside, and where the leg can fold against the underside of the slatted table.

5. The table saw of claim 1, where the outfeed table includes a slatted table with a rear portion distal from the rear edge of the main table, and where the outfeed table includes at least one roller adjacent the rear potion of the slatted table.

6. The table saw of claim 1, where the outfeed table includes a slatted table and a stabilizing plate.

7. The table saw of claim 1, where the outfeed table includes a slatted table made from at least four tubes.

8. The table saw of claim 7, further comprising a stabilizing plate between at least two of the tubes.

9. The table saw of claim 8, further comprising a dust port at the rear of the housing, and where the stabilizing plate is positioned not to interfere with the dust port when the outfeed table is in the folded position.
